(19) United States
(12) Patent Application Publication
(10) Pub. No.: US 2007/0085381 A1
(43) Pub. Date: Apr. 19, 2007

(54) D-PILLAR STRUCTURE FOR A REAR VEHICLE BODY STRUCTURE

(75) Inventors: Ryan Delaney, Belleville, MI (US); Shawn Morgans, Chelsea, MI (US); Mike Paiva, Novi, MI (US); John Comiez, Farmington, MI (US)

Correspondence Address: ARTZ & ARTZ, P.C., 28333 TELEGRAPH ROAD, SUITE 250, SOUTHFIELD, MI, 48034, US

(73) Assignee: FORD GLOBAL TECHNOLOGIES, LLC, Dearborn, MI (US)

(21) Appl. No.: 11/163,452

(22) Filed: Oct. 19, 2005

(51) Int. Cl. B60J 7/00

(52) U.S. Cl. 296/193.08

(57) ABSTRACT

A D-pillar structure for a rear vehicle body structure. The D-pillar structure is a one-piece hydroformed tube configured for supporting and positioning a rear vehicle body structure within a predetermined tolerance. The rear vehicle body structure is a cargo box inner, a tailgate, and/or a pair of fenders.

### CROSS-REFERENCE TO RELATED APPLICATION

The present invention is related to U.S. non-provisional application Ser. No. 11/163447 filed on Oct. 19, 2005, and entitled “CARGO BOX INNER FOR A VEHICLE” (Attorney Docket No. 81126751/FGT-1972), the disclosure of which is incorporated by reference herein.

### TECHNICAL FIELD

The present invention relates generally to vehicles, and more particularly to a D-pillar structure for a rear vehicle body structure.

### BACKGROUND

Cargo box inners (“cargo boxes”) typically are mounted to a vehicle frame by D-pillars and cross sills. These cargo boxes usually define an open-top bed behind a passenger cabin of a truck, and thus are also known as pickup boxes, truck boxes, pickup truck boxes, and truck bed boxes.

Cargo boxes typically are built on and supported by a welded assembly of separate stampings, namely two (2) D-pillars and a cross sill. In this way, the cargo boxes can have a somewhat high amount of dimensional variation therein. In particular, each D-pillar and cross sill is stamped with its own tolerance. Additional tolerances are introduced by the processes of welding the individual stampings together and then building the cargo box on the welded assembly.

It would therefore be desirable to provide a D-pillar structure that minimizes the dimensional variation of the cargo boxes, strengthens those cargo boxes, decreases the manufacturing cycle time, and lowers the costs associated therewith.

### SUMMARY OF THE INVENTION

A D-pillar structure for a rear vehicle body structure is provided. The D-pillar structure is a one-piece hydroformed tube configured for supporting and positioning a rear vehicle body structure within a predetermined tolerance. The rear vehicle body structure includes a cargo box inner, a tailgate, and/or a pair of fenders.

One advantage of the invention is that a D-pillar structure is provided that has a substantially stiff and durable construction.

Another advantage of the invention is that a D-pillar structure is provided that eliminates joints between mating components that could otherwise weaken a vehicle body structure.

Yet another advantage of the invention is that a D-pillar structure is provided that has substantially few parts and thus minimizes assembly operations associated therewith.

Still another advantage of the invention is that a D-pillar structure is provided that enhances the fit between rear vehicle body structures.

Yet another advantage of the invention is that a D-pillar structure is provided that improves the cab-to-box margin and the flushness measurements for the vehicle.

Still another advantage of the invention is that a D-pillar structure is provided that decreases the piece and tooling costs.

Yet another advantage of the invention is that a D-pillar structure is provided that is manufactured more quickly than a conventional D-pillar assembly comprised of separate stampings welded together.

Other advantages of the present invention will become apparent upon considering the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of the examples of the invention:

FIG. 1 is a rear perspective view of a vehicle having a rear vehicle body structure with a D-pillar structure, according to one advantageous embodiment of the claimed invention.

FIG. 2 is a fully exploded view of the cargo box inner shown in FIG. 1, illustrating the cargo box inner comprised of individual composite panels attached to the D-pillar structure.

FIG. 3 is a cross-sectional view of the vehicle shown in FIG. 1, as taken along line 3-3, illustrating the D-pillar structure having a one-piece construction with the cargo box inner attached thereto.

FIG. 4 is a partially exploded view of the vehicle shown in FIG. 1, illustrating the D-pillar structure attaching a cargo box inner, a tailgate, and a pair of fenders to a vehicle frame.

FIG. 5 is a cross-sectional view of the vehicle shown FIG. 1, as taken along line 5-5.

FIG. 6 is a perspective view of the cargo box inner shown in FIG. 4, as taken along reference arrow 6.

FIG. 7 is a perspective view of the cargo box inner shown in FIG. 4, as taken along reference arrow 7.

FIG. 8 is an enlarged view of the cargo box structure shown in FIG. 8 and encircled within circle 8.

### DETAILED DESCRIPTION OF THE INVENTION

In the following figures, the same reference numerals are used to identify the same components in the various views.

The present invention is particularly suited for a D-pillar structure for attaching a cargo box inner (“cargo box”), a tailgate, and a pair of fenders to a vehicle frame. To that end, the embodiments described herein employ structural features where the context permits. However, various other embodiments are contemplated having different combinations of the described features, having additional features other than those described herein, or even lacking one or more of those features. In this respect, the D-pillar structure can be utilized for installing other suitable body structures on a vehicle frame.

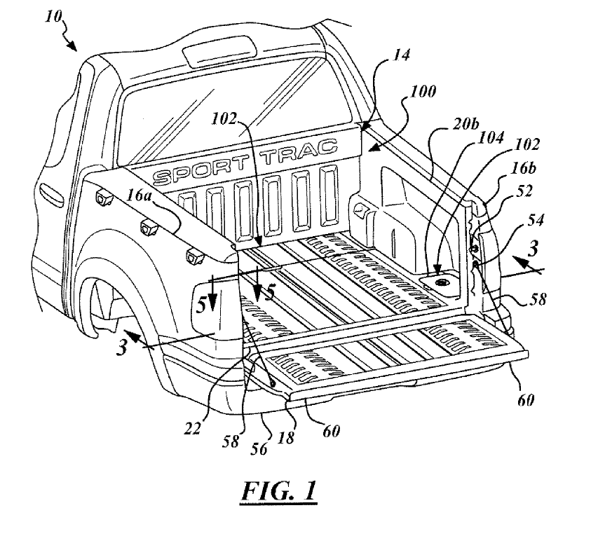

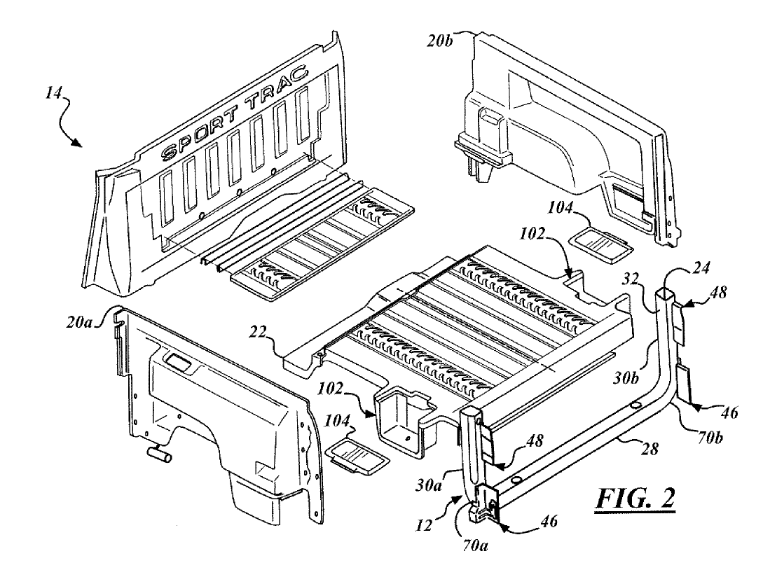

Referring now to FIG. 1, there is shown a perspective view of a sports utility vehicle (“SUV”) 10 with a series of rear vehicle body structures installed therein by a D-pillar structure 12 (shown in FIG. 2). In this embodiment, the rear vehicle body structures include a cargo box inner 14 (“cargo box”), a pair of fenders 16a, 16b, and a tailgate 18.

As shown in FIG. 2, the cargo box 14 is comprised of a series of individual composite panels with rear end portions attached to the D-pillar structure 12. These panels include two (2) sidewall panels 20a, 20b and a floor panel 22. However, it is contemplated that the cargo box 14 can instead be a single-piece construction and/or have other portions attached to the D-pillar structure 12. Also, as shown in FIG. 1, the panels define a cargo bed 100 with one or more storage bins 102 between adjacent panels 20b, 22. Each storage bin 102 is covered by a lid 104, which is sufficiently durable for supporting cargo.

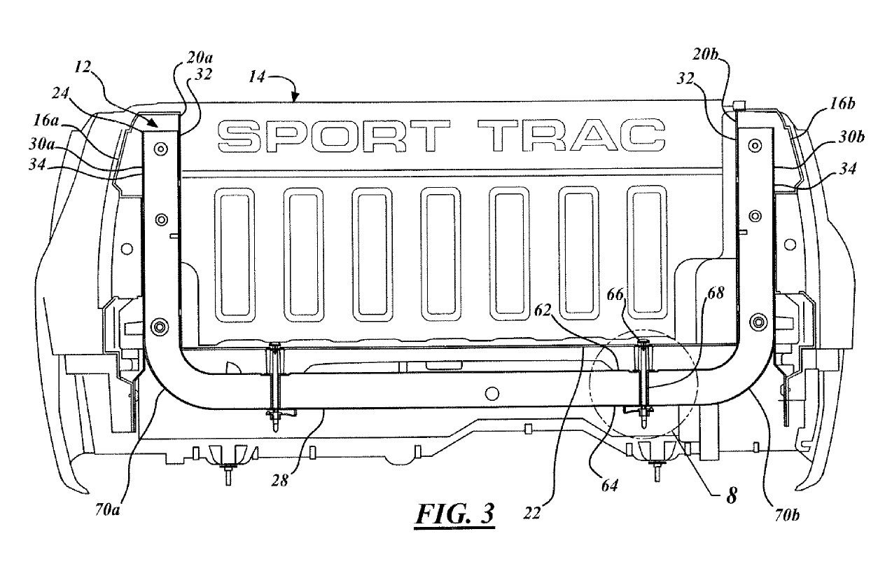

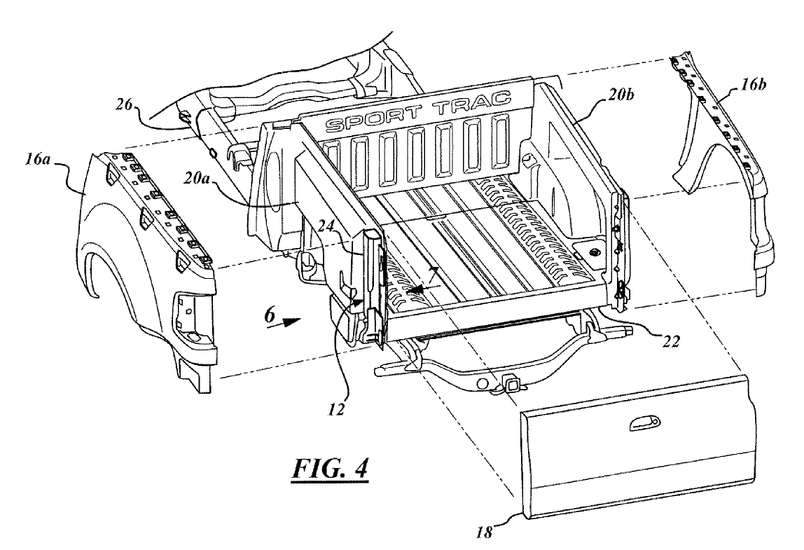

With attention now to FIGS. 3 and 4, the D-pillar structure 12 is comprised of a one-piece hydroformed tube 24 (“tube”) configured for supporting the rear vehicle body structures 18, 20a, 20b, 22 on a vehicle frame 26. It will be appreciated that hydroforming the tube 24 is beneficial for producing the tube 24 within substantially low dimensional tolerances. Also, in this regard, the tube 24 enhances the alignment between the rear vehicle body structures 18, 20a, 20b, and 22. In addition, hydroforming the one-piece tube 24 is accomplished within a substantially short cycle time and at a significantly lower cost than the conventional processes of stamping the separate components and then welding them together.

As best shown in FIG. 3, the tube 24 has a generally U-shaped construction with a cross sill portion 28 and two (2) D-pillar portions 30a, 30b. The cross sill portion 28 has the cargo box 14 attached thereto. Also, the D-pillar portions 30a, 30b have the cargo box 14, the fenders 16a, 16b, and the tailgate 18 (shown in FIGS. 1 and 2) attached thereto.

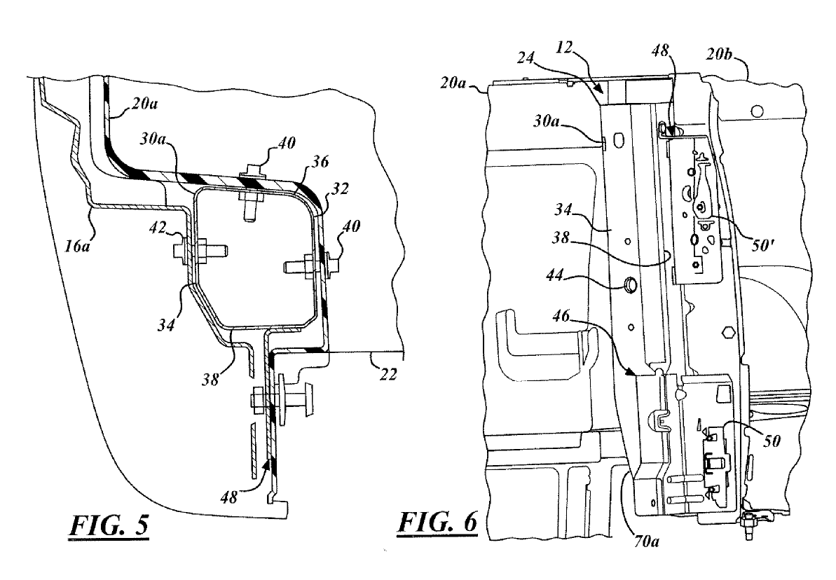

With specific attention to FIG. 5, each D-pillar portion 30a has an inboard surface 32, an outboard surface 34, a forward surface 36, and a rear surface 38. The inboard surface 32 and the forward surface 36 are attached directly to the respective sidewall panel 20a by one or more bolt members 40. The outboard surface 34 is attached directly to the respective fender 16a by one or more bolt members 42. 31 As shown in FIG. 6, the outboard surface 34 has a four-way locating recess 44 for positioning the fender 16a in a predetermined location (shown in FIGS. 1 and 4). As detailed below, the rear surface 38 is attached to the tailgate 18 and the respective fender 16a by one or more plate assemblies. It is contemplated that the tailgate 18 and the fenders 16a, 16b (shown in FIGS. 1 and 3) can instead be attached directly to the D-pillar portions 30a, 30b.

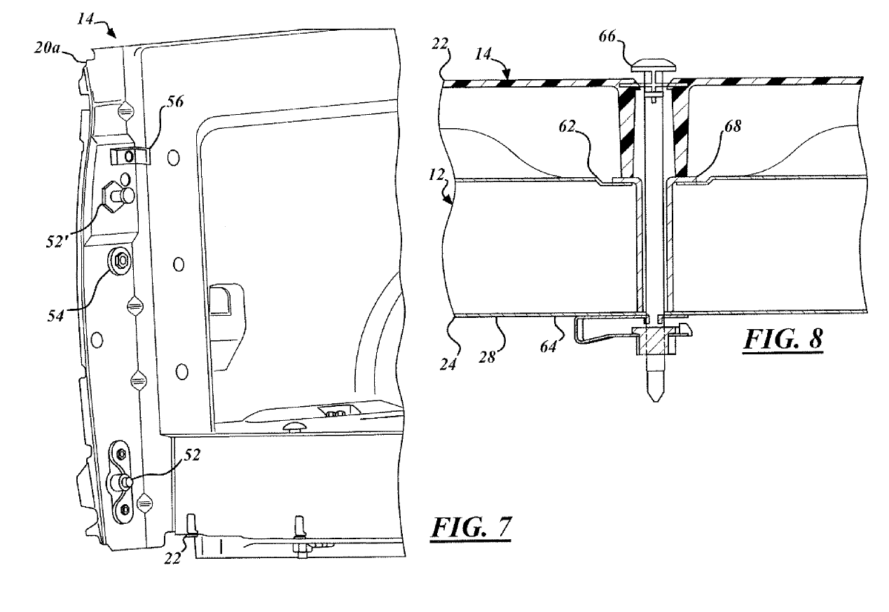

The plate assemblies include a hinge plate assembly 46 and a striker plate assembly 48. In this embodiment, the hinge plate assembly 46 has a floating double M10 nut plate 50 (shown in FIG. 6) and a tailgate-hinge attachment device 52 (shown in FIG. 7), which extends through the sidewall panel 20a for pivotally attaching the tailgate 18 to the hinge plate assembly 46. 33 The striker plate assembly 48 has a floating M10 nut plate 50′ (shown in FIG. 6) and a tailgate-striker device 52′ (shown in FIG. 7), which latches the tailgate 18 in a closed position. Also, as shown in FIG. 7, the striker plate assembly 48 further includes a check-strap attachment device 54 and an anti-chuck tailgate bumper 56. The check-strap attachment device 54 is utilized for attaching a check strap 58 (shown in FIG. 1) to a top portion 60 of the tailgate 18. The bumper 56 aligns the tailgate 18 in a predetermined position and minimizes wear on the sidewall panel 20a and the tailgate 18.

Referring now to FIG. 8, there is shown an enlarged view of the cross sill portion 28, as taken from FIG. 3 and encircled by circle 8. In this embodiment, the cross sill portion 28 has a top surface 62 and a bottom surface 64, which are attached to the floor panel 22 of the cargo box 14 by a bolt fastener 66. Additionally, the top surface 62 and the bottom surface 64 have a bridge member 68 therebetween for distributing a load across the tube 24 and hence improving its durability.

Referring back to FIG. 3, the D-pillar portions 30a, 30b and the cross sill portion 28 have two (2) rounded corner portions 70a, 70b therebetween for minimizing localized or otherwise concentrated stress in the D-pillar structure 12 that could weaken the structure 12.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

What is claimed is:

1. A D-pillar structure for a vehicle, comprising:
a one-piece hydroformed tube configured for supporting and positioning a rear vehicle body structure within a predetermined tolerance;
said rear vehicle body structure comprised of at least one of a cargo box inner, a tailgate, and a pair of fenders.

2. The D-pillar structure recited in claim 1 wherein said one-piece hydroformed tube is comprised of a cross sill portion and a pair of D-pillar portions.

3. The D-pillar structure recited in claim 2 wherein said pair of D-pillar portions and said cross sill portion have a rounded corner portion therebetween for decreasing stress therein and strengthening said one-piece hydroformed tube.

4. The D-pillar structure recited in claim 2 wherein said cross sill portion is attached to a floor structure for said cargo box inner.

5. The D-pillar structure recited in claim 2 wherein said pair of D-pillar portions is attached to at least one of said tailgate, said pair of fenders, and a pair of sidewall structures for said cargo inner box.

6. The D-pillar structure recited in claim 4 wherein said one-piece hydroformed tube is attached to a rear portion of said pair of fenders and said cargo box inner.

7. A cargo box assembly, comprising:
said D-pillar structure recited in claim 2 with said cargo box inner comprised of a plurality of panels; and
said one-piece hydroformed tube having said plurality of panels attached thereto.

8. The cargo box assembly recited in claim 7 wherein said cross sill portion has at least one of a top surface and a bottom surface attached to at least one of said panels.

9. The cargo box assembly recited in claim 7 wherein said cross sill portion has at least one of said panels attached thereto by at least one bolt member.

10. The cargo box assembly recited in claim 7 wherein said cross sill portion has at least one bridge member therein supporting at least one of said panels and distributing force across said cross sill portion.

11. The cargo box assembly recited in claim 7 wherein said pair of D-pillar portions has at least one of an inboard surface and a forward surface attached to at least one of said panels.

12. The cargo box assembly recited in claim 7 wherein said pair of D-pillar portions has at least one of an outboard surface and a rear surface attached to said pair of fenders.

13. The cargo box assembly recited in claim 7 wherein said pair of D-pillar portions has a rear surface attached to said tailgate.

14. The cargo box assembly recited in claim 7 wherein said pair of D-pillar portions is attached to at least one of said tailgate and said pair of fenders by at least one plate assembly.

15. The cargo box assembly recited in claim 14 wherein said at least one plate assembly includes at a hinge plate assembly and a striker plate assembly.

16. The cargo box assembly recited in claim 7 wherein said cargo box inner further comprises
said plurality of panels forming a cargo bed and comprised of a composite material;
at least one pair of said composite panels defining a storage bin adjacent to said cargo bed; and
a lid covering said storage bin and further defining said cargo bed.

17. A vehicle comprising:
a vehicle frame; and said cargo box assembly recited in claim 7 with said rear vehicle body structure attached to said vehicle frame by said one-piece hydroformed tube.

18. A cargo box assembly, comprising:
a rear vehicle body structure comprised of at least one of a cargo box inner, a tailgate, and
a pair of fenders;
a one-piece hydroformed tube supporting said rear vehicle body structure;
said one-piece hydroformed tube having at least one locating structure positioning said rear vehicle body structure within a predetermined tolerance.

19. The cargo box assembly recited in claim 18 further comprising:
said cargo box inner comprised of a pair of sidewall panels and a floor panel;
said one-piece hydroformed tube having a generally U-shaped configuration comprised of a pair of D-pillar portions and a cross sill portion;
said pair of D-pillar portions and said cross sill portion with a rounded portion therebetween for decreasing stress in said one-piece hydroformed tube;
said cross sill portion having at least one bridge member therein and attached to said floor panel;
said at least one bridge member distributing force across said cross sill portion;
said pair of D-pillar portions attached directly to said cargo box inner and said pair of fenders;
said pair of D-pillar portions attached to said tailgate and said pair of fenders by at least one plate assembly;
said at least one plate assembly including a hinge plate assembly and a striker plate assembly;
said hinge plate assembly attached directly to said fender and pivotally attached to said tailgate;
said striker plate assembly including an anti-chuck bumper, a latch striker, and a check-strap member for said tailgate;
said pair of D-pillars having at least one bed-extender mounting structure for attaching to a bed extender for said cargo box inner.

20. A vehicle comprising:
a vehicle frame; and
said cargo box assembly recited in claim 18 with said rear vehicle body structure attached to said vehicle frame by said one-piece hydroformed tube.
